(19) United States
(12) Patent Application Publication
(10) Pub. No.: US 2007/0049325 A1
(43) Pub. Date: Mar. 1, 2007

(54) Method and apparatus for reselecting a cell in a network with the hierarchical cell structure

(75) Inventor: Dong-Keun Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/508,817

(22) Filed: Aug. 24, 2006

(30) Foreign Application Priority Data
Aug. 25, 2005 (KR) 10-2005-0078486

(51) Int. Cl. H04B 7/00; H04Q 7/20

(52) U.S. Cl. 455/525

(57) ABSTRACT

A method and apparatus for reselecting a cell in the network with the hierarchical cell structure, are provided. According to an embodiment, the method includes measuring a received signal code power of each of a current serving cell and adjacent cells; and designating the current serving cell as a candidate cell for a next serving cell in a cell reselection process, if the received signal code power of the current serving cell is the strongest of all the cells.

This application claims the priority benefit of the Korean Patent Application No. 10-2005-0078486, filed on Aug. 25, 2005, which is hereby incorporated by reference as if fully set forth herein.

### BACKGROUND OF THE INVENTION

1. Field of the Invention

The present invention relates to a method and apparatus for reselecting a cell, and more particularly to a method and apparatus for reselecting a cell in a network with the hierarchical cell structure.

2. Description of the Background Art

A service area in a mobile telecommunication system is categorized into a mega cell, a macro cell, a micro cell, and a pico cell depending on a service coverage and a transmission rate defined in the international standards. The cell coverage varies with the cell size.

Generally, the mega cell has a wide coverage area spanning 100-500 km in radius using a satellite telecommunication network and provides data and voice services at a transmission rate of 9.6 kbps. The macro cell has a coverage area spanning 35 km in radius and provides the data and voice services at a transmission rate of 64 kbps. The macro cell is used by the mobile telecommunication system to extend coverage in an area such as a suburb where there is less telecommunication traffic.

The micro cell has a coverage area spanning 0.5-1 km in radius and provides the data and voice services at a transmission rate of 128 kbps. The micro cell uses a line-of-sight path between a base station and a moving station, as a main transmission path.

The pico cell has a coverage area spanning 50 m in radius and provides the data and voice services using an optical repeater or a small relay station installed in a building and a basement in a densely built area. A dedicated line (E1 line) is connected to the optical repeater (i.e., pico BTS) from the base station to provide the data and voice services in the building. The small relay station receives an over-the-air signal and provides the data and voice services to the basement using an omni or patch antenna.

The cells in order of ascending size in the hierarchical cell structure are the pico cell, the micro cell, the macro cell, and the mega cell. The cells partially or wholly overlap with each other. The data transmission rate is the highest in the pico cell and the lowest in the mega cell.

In the hierarchical cell structure, it is possible to selectively use a cell of which a signal reception sensitivity and a channel quality are superior to those of other cells to provide the best voice and data services.

FIG. 1 is a view of the hierarchical cell structure showing a relationship of the pico cell with the micro cell according to the background art.

The radius of the macro cell used largely in the wireless mobile telecommunication is in a range of 5 km to 30 km. The micro cell, of which the radius is in a range of 500 m to 1 km, is used to provide coverage in building, subways systems, and tunnels. The radius of the mini cell is somewhere between those of the macro cell and the micro cell. The pico cell, of which the radius is less than 200 m is a spot coverage and low-capacity site. The mega cell, of which the radius is in a range of more than 100 km, is used in the mobile telecommunication service using a satellite in a low circular orbit.

Referring to FIG. 2, a process of selecting and reselecting a cell in the network with the hierarchical cell structure according to the background art is now described.

A mobile handset, when switched ON or initialized, begins to search for adjacent cells (S201). The mobile handset measures a received signal code power (RSCP) of each of the cells which are searched for (S202).

The mobile handset chooses the cell of which the RSCP is the strongest (S203). When an Energy per Chip to Noise Ratio (E_{c}/N₀) and the RSCP of a signal received from the selected cell are greater than preset threshold values, i.e., Q_{rxlevMin} and Q_{qualMin}, respectively, the chosen cell is selected as a current serving cell (S204). That is, the mobile handset selects as the current serving cell the cell of which the RSCP is the strongest and of which the RSCP and the Energy per Chip to Noise Ratio are greater than preset threshold values, i.e., Q_{rxlevMin} and Q_{qualMin}, respectively. Then, the mobile handset goes into an idle mode and periodically or continuously searches for the adjacent cells (S205 through S206), and measures the Energy per Chip to Noise Ratio (E_{c}/N₀) of each of the adjacent cells (S207). The mobile handset calculates H_{criteria} of each of the adjacent cells based on the measured Energy per Chip to Noise Ratios. The cell of which H_{criteria} is greater than “0” is designated as a candidate cell for a serving cell (S208). The mobile. handset selects the cell which has the best signal reception condition, from the candidate cells (S209).

If the cell reselection process is applied as described above, when H_{criteria} of the current serving cell is less than Q_{qualMin}, the current serving cell may be excluded which has the strongest RSCP at an initial phase.

A ping-pong phenomenon wherein the cell selection and reselection process repeats and thereby the process of position registration repeats, occurs when a location area identifier (LAI) of the current serving sell is different from that of the adjacent cell and H_{criteria} of the serving cell is less than “0”, although the Energy per Chip to Noise Ratio and the RSCP of the current serving cell are greater than preset threshold values, i.e., Q_{rxlevMin} and Q_{qualMin}, respectively,

The ping pong phenomenon, which occurs in the conventional cell selection and reselection process, is described in the following four steps.

STEP 1: A cell “A” is selected as a current serving cell and a process of position registration of the cell “A” proceeds.

STEP 2: During the selection of the cell “A”, a cell reselection occurs because H_{criteria} of the cell “A” is less than “0”. A cell “B” is reselected and the process of position registration of the cell “A” discontinues. The process of position registration of the cell “B” proceeds.

STEP 3: The process of position registration of the cell “B” finishes.

STEP 4: The cell “A” is reselected as the serving cell because the RSCP of the cell “A” is stronger than that of the cell “B”.

In the conventional cell selection and reselection process, the ping pong phenomenon wherein the steps 1 through 4 are indefinitely repeated, occurs when the Energy per Chip to Noise Ratio and the RSCP of the current serving cell are excellent, but H_{criteria} of the current serving cell is less than “0”, which is a problem.

### BRIEF DESCRIPTION OF THE INVENTION

An object of the present invention is to provide a cell selection and reselection method for preventing a cell reselection from occurring in a network with the hierarchical cell structure when an electric field strength of a current serving cell is greater than a threshold value preset in a mobile handset, although an Energy per Chip to Noise Ratio of a current serving cell does not satisfy requirements of a network.

Another object of the present invention is to provide a cell selection and reselection method and device which address the limitations and problems associated with the background art.

According to an aspect, the present invention provides a cell selection and reselection method for preventing a cell reselection from occurring when a received signal code power and an Energy per Chip to Noise Ratio of the serving cell are respectively greater than threshold values, i.e., Q_{rxlevMin} and Q_{qualMin} preset in a mobile handset although an Energy per Chip to Noise Ratio of a serving cell is less than a reference value of a network.

According to an aspect of the present invention, there is provided a method for reselecting a serving cell in a mobile handset, including measuring a received signal code power (RSCP) of a current serving cell and adjacent cells and designating the current serving cell as a candidate cell for a serving cell when the current serving cell has the strongest RSCP of all cells.

According to another aspect of the present, there is provided a method for reselecting a cell in a mobile handset, including measuring a received signal code power and a Energy per Chip to Noise Ratio of each of a current serving cell and adjacent cells which the mobile handset searches for, designating as a candidate cell for a serving cell the current serving cell of which the received signal code power is the strongest of all cells, designating as a candidate cell for a serving cell the adjacent cell of which the signal to the measured noise ratio is greater than a reference value (Q_{hcs}), and reselecting the current serving cell from the candidate cells.

According to another aspect of the present, there is provided a method for reselecting a cell in a mobile handset, including checking if a ping pong phenomenon occurs, measuring a received signal code power and a signal quality of a current serving cell when a number of occurrence of the ping pong phenomenon exceeds a specified number, and discontinuing a reselection process when the received signal code power and the signal quality are greater than thresholds values, Q_{rxlevMin} and Q_{qualMin}, respectively.

According to another aspect of the present invention, there is provided a mobile handset including a signal receiving unit receiving a signal from a current serving cell and adjacent cells, a signal measuring unit measuring a received signal code power and an Energy per Chip to Noise Ratio of a signal which is received from each of the current serving cell and the adjacent cell, a memory storing values measured by the signal measuring unit and reference values for cell reselection, and a processor performing a process of reselecting a serving cell from candidate cells including the current serving cell which is designated as a candidate cell for a serving cell because the current serving cell has the strongest received signal code power.

According to another aspect of the present invention, there is provided a mobile handset including a signal receiving unit receiving a signal from a current serving cell and adjacent cells, a received signal measuring unit measuring a received signal code power and an Energy per Chip to Noise Ratio of a signal received from each of the current cell and the adjacent cell, a memory storing values measured by the received signal measurement unit and threshold values (Q_{rxlevMin} and Q_{qualMin}) for cell reselection, and a processor discontinuing a reselection of a serving cell when the received signal code power and the Energy per Chip to Noise Ratio of the current serving cell are respectively greater than the threshold values (Q_{rxlevMin} and Q_{qualMin,}) stored in the memory.

According to another aspect of the present invention, there is provided a method for selecting and reselecting a cell in a mobile handset, comprising: measuring a received signal code power of each of a current serving cell and adjacent cells; and designating the current serving cell as a candidate cell for a next serving cell in a cell reselection process, if the received signal code power of the current serving cell is the strongest of all the cells.

According to another aspect of the present invention, there is provided a method for selecting and reselecting a cell in a mobile handset, comprising: measuring a received signal code power and an Energy per Chip to Noise Ratio of each of a current serving cell of the mobile handset and adjacent cells searched by the mobile handset; designating the current serving cell as a candidate cell for a next serving cell in a cell reselection when the received signal code power of the current serving cell is the strongest of all the cells; designating, as a candidate cell for the next serving cell in a cell reselection, any of the adjacent cell of which the measured Energy per Chip to Noise Ratio value satisfies a reference value (Q_{hcs}); and selecting a serving cell from the candidate cells.

According to another aspect of the present invention, there is provided a mobile handset comprising: a signal receiving unit receiving a signal from each of a current serving cell and adjacent cells; a received signal measuring unit measuring a received signal code power and an Energy per Chip to Noise Ratio of the signal received from each of the current serving cell and the adjacent cells; a memory storing values measured by the received signal measuring unit and reference values (Q_{hcs}) for cell reselection; and a processor performing a process of automatically designating the current serving cell as a candidate cell for a next serving cell in a cell reselection if the current serving cell has the strongest received signal code power among all cells.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view of the hierarchical cell structure showing a relationship of a pico cell with a micro cell according to the background art;

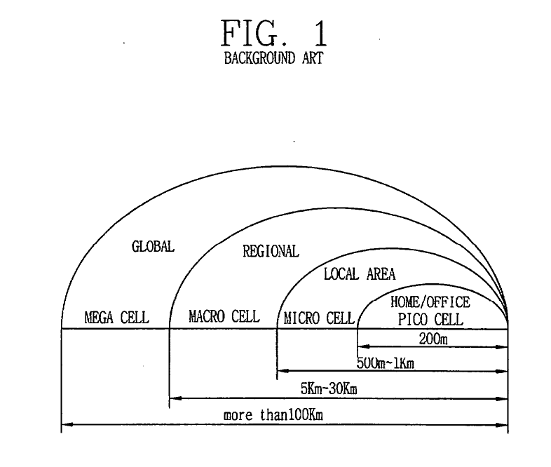

FIG. 2 is a flow chart showing a conventional process of cell selection and reselection according to the background art;

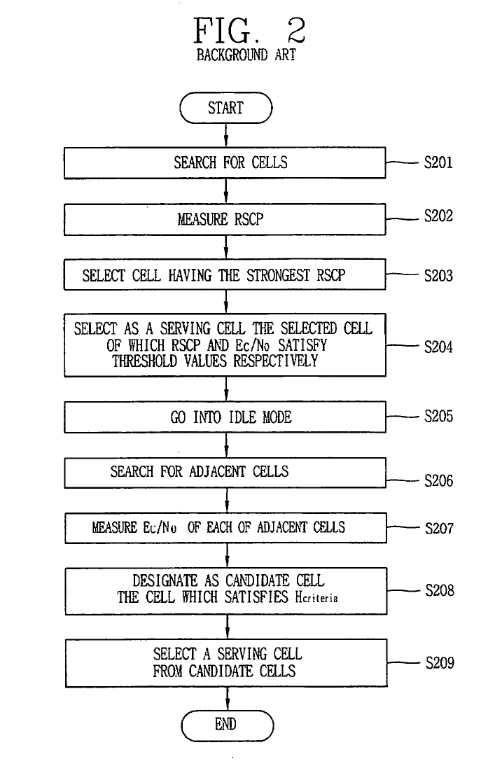

FIG. 3 is a flow chart showing a process of cell selection and reselection according to an embodiment of the present invention;

FIG. 4 is a flow chart showing a process of cell selection and reselection according to another embodiment of the present invention; and

FIG. 5 shows an example of a configuration of the mobile handset to select and reselect a cell according to the present invention.

### DETAILED DESCRIPTION OF THE PREFERRED EMBODIMENTS

Reference will now be made in detail to the preferred embodiments of the present invention, examples of which are illustrated in the accompanying drawings.

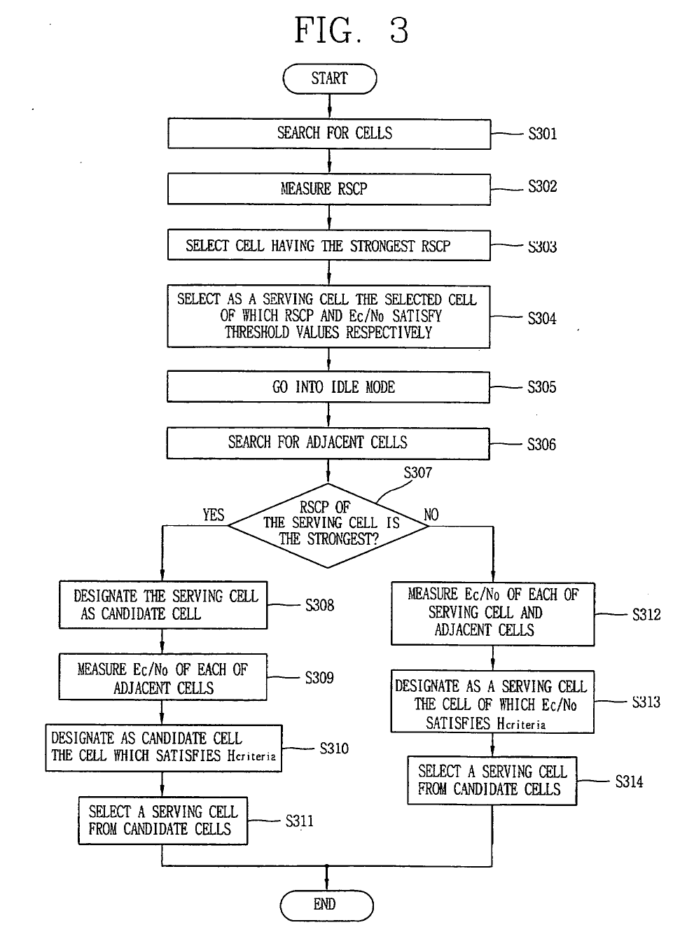

FIG. 3 is a flow chart showing a process of cell selection and reselection according to an embodiment of the present invention.

A mobile handset (e.g., a mobile terminal such as a mobile phone, etc.), when switched ON or initialized, begins to search for adjacent cells (S301). The mobile handset measures a received signal code power (RSCP) of the adjacent cells which are searched for (S302).

The mobile handset chooses the cell of which the RSCP is the strongest (S303). When the searched-after cell satisfies both of threshold values, i.e., Q_{rxlevMin} and Q_{qualMin}, which are stored in a memory of the mobile handset, the searched-after cell is designated as a serving cell (S304). Q_{rxlevMin} indicates a minimum reception level (dBm) in a cell. Q_{qualMin} indicates a minimum quality level (dB) in a cell. When the searched-after cell satisfies both of the threshold values, the RSCP and the Energy per Chip to Noise Ratio of the searched-after cell are greater than Q_{rxlevMin} and Q_{qualMin} respectively. As a result, the mobile handset selects as a current serving cell the cell of which the RSCP is the strongest and of which the RSCP and the Energy per Chip to Noise Ratio are greater than Q_{rxlevMin} and Q_{qualMin} respectively (S304).

Then, the mobile handset goes into an idle mode and periodically or continuously searches for the adjacent cells (S305 through S306). The mobile handset compares the RSCP of the searched-after adjacent cells with that of the current serving cell to check if the RSCP of the current serving cell is the strongest of all cells (S307)

The current serving cell, when having the strongest RSCP among all cells, is designated as a candidate cell to be possibly selected as a next serving cell (S308). The adjacent cell(s), if they satisfy the H_{criteria} as a result of measuring the Energy per Chip to Noise Ratio of the adjacent cell(s), is (are) also designated as a candidate cell for a possible selection as the next serving cell (S309 and S310).

Therefore, the current serving cell and the adjacent cell are given an opportunity to be reselected as a serving cell. The mobile handset selects the cell having the best signal reception condition, from all the candidate cells for the next serving cell (S311).

H_{criteria} indicates the reference value for cell reselection in the network with the hierarchical cell structure. H_{criteria} is given by:
H_{criteria}=Qₘₑₐₛ−Q_{hcs} Formula (1)
where Qₘₑₐₛ is the Energy per Chip to Noise Ratio (E_{c}/N₀) measured by the mobile handset and Q_{hcs} is a reference value obtained from the network by the mobile handset which selects the current serving cell. In step S310, to satisfy H_{criteia} means that H_{criteria} is greater than “0”.

On the other hand, at step S307, if the RSCP of the current serving cell is not greater than that of the adjacent cell(s), the mobile handset measures the Energy per Chip to Noise Ratio of the current serving cell and the adjacent cells (S312) and designates, as a candidate cell for a possible selection as the next serving cell, any cell which satisfies H_{criteria} (S313). The mobile handset selects the cell having the best signal reception condition, from all the candidate cells (S314). The current serving cell may be selected or excluded from the candidate cells depending on H_{criteria} given by Formula (1) above.

The mobile handset according to the present invention designates the current serving cell as a candidate cell for a next serving cell without checking if the current serving cell satisfies H_{criteria} when the current serving cell has the strongest RSCP of all cells during a reselection process.

For explanation of an example of the cell selection and reselection of the present invention, assume that the threshold value of the RSCP (Q_{qualMin}) preset in the mobile handset, the threshold value (Q_{rxlevMin}) of the Energy per Chip to Noise Ratio (E_{c}/N₀), and the RSCPs, the Energy per Chip to Noise Ratios (E_{c}/N₀), and Q_{hcs}'s of cells A and B which are searched for by the mobile handset are as shown in the following table.

| | | | |
|---|---|---|---|
| (measured | Q_{rxlevMin}: 25 | (CELL “A”) RSCP: 30 | (CELL “B”) RSCP: 20 |
| by the | Q_{qualMin}: 15 | E_{c}/N₀: 20 | E_{c}/N₀: 10 |
| mobile | | Q_{hcs}: 48 | Q_{hcs}: 0 |
| handset) | | | |

The mobile handset selects the cell “A” because the RSCP (30) of the cell “A” is greater than that (20) of the cell “B”. The mobile handset checks if the RSCP and the E_{c}/N₀ of the cell “A” are greater than Q_{rxlevMin} and Q_{qualMin}, respectively. The cell “A” is selected as the current serving cell (S304) because the RSCP (30) of the cell “A” is greater than Q_{rxlevMin}(=25), and the E_{c}/N₀ (20) of the cell “A” is greater than Q_{qualMin}(=15).

The mobile handset in the idle mode (S305 and S306) searches for a cell to be designated as a candidate cell for the next serving cell in the cell reselection process. In this example, the cell “A” is designated as a candidate cell regardless of H_{criteia} of the cell “A” because the cell “A” has the strongest RSCP of all cells (S308). The cell “B” is also designated as a candidate cell because H_{criteria} of the cell “B” is greater than “0” (S310).

The mobile handset reselects the next serving cell from the cell “A” and the cell “B”. The current serving cell “A” is reselected as the serving cell because the signal quality and RSCP of the cell “A” are superior to those of the cell “B” (S311).

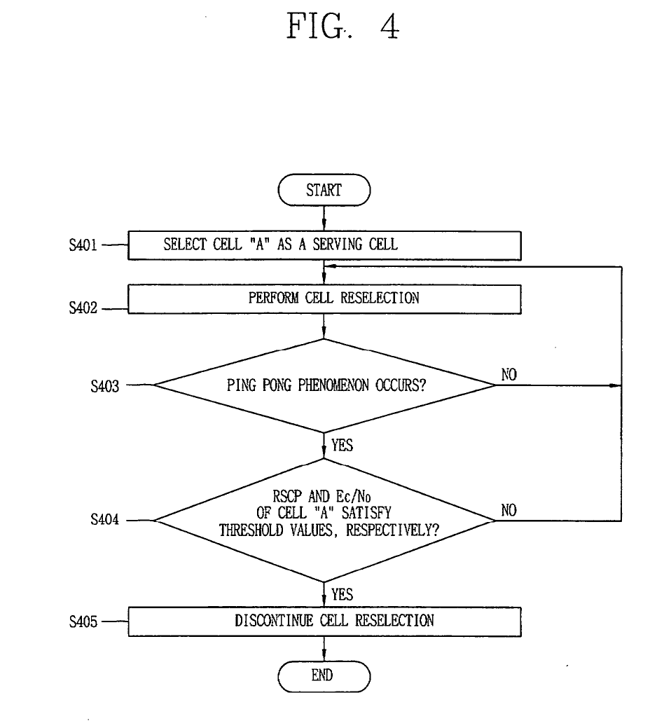

FIG. 4 is a flow chart showing a process of cell selection and reselection according to another embodiment of the present invention. As shown in FIG. 4, the mobile handset, when switched ON or initialized, begins to search for adjacent cells and selects a cell “A” as a current serving cell (S401). The cell “A” has the strongest RSCP of all cells which are searched for by the mobile handset. The RSCP and the Energy per Chip to Noise Ratio of the cell “A” are greater than Q_{rxlevMin} and Q_{qualMin}, respectively.

Then the mobile handset in the idle mode searches for the adjacent cells and then proceeds to perform a cell reselection (S402). At this point, the ping pong phenomenon, wherein the cell selection and reselection process are repeated and thereby the process of position registration is repeated, occurs between the cell “A” and other cell(s).

When the ping pong phenomenon (once or certain number of times) occurs between the cell “A” and other cell, the mobile handset checks if the RSCP and E_{c}/N₀ of the cell “A” are greater than Q_{rxlevMin} and Q_{qualMin}, respectively (S403 and S404). Then the mobile handset discontinues the cell reselection if the conditions are satisfied, i.e., when the RSCP and E_{c}/N₀ of the cell “A” are greater than Q_{rxlevMin} and Q_{qualMin} respectively (S405), whereby the cell “A” is maintained as the serving cell.

In checking if the ping pong phenomenon occurs during steps S404 and S405, when a cell “A” is initially selected as a new serving cell in the cell reselection process, then the cell “B” is selected as the new serving cell, and thereafter the cell “A” is selected again as the new serving cell, this is defined as the ping pong phenomenon occurring one time. A number of occurrences of the ping pong phenomenon is determined during steps S404 and S405.

For explanation of the cell selection and reselection of FIG. 4, assume again that the threshold value of the RSCP (Q_{rxlevMin}) preset in the mobile handset, the threshold value (Q_{qualMin}) of the Energy per Chip to Noise Ratio (E_{c}/N₀), and the RSCPs, the Energy per Chip to Noise Ratios (E_{c}/N₀), and Q_{hcs}'s of the cells A and B which are searched after by the mobile handset are as shown in the following table.

| | | | |
|---|---|---|---|
| (measured | Q_{rxlevMin}: 25 | (CELL “A”) RSCP: 30 | (CELL “B”) RSCP: 20 |
| by the | Q_{qualMin}: 15 | E_{c}/N₀: 20 | E_{c}/N₀: 10 |
| mobile | | Q_{hcs}: 48 | Q_{hcs}: 0 |
| handset) | | | |

The mobile handset selects the cell “A” because the RSCP of the cell A is greater than that of the cell “B”. The mobile handset checks if the RSCP and the E_{c}/N₀ of the cell “A” are greater than Q_{rxlevMin} and Q_{qualMin}, respectively. The cell “A” is selected as the current serving cell because the RSCP (30) of the cell “A” is greater than Q_{rxlevMin}(=25), and the E_{c}/N₀ (20) of the cell “A” is greater than Q_{qualMin}(=15).

The mobile handset in the idle mode searches for cells to be designated as a candidate cell for a next serving cell in the cell reselection. In this example, the cell “A” is excluded from being a candidate cell for the next serving cell because H_{criteria}(=Qₘₑₐₛ−Q_{hcs}=20−48=−28) of the cell “A” is less than “0”. Instead, the cell “B”is designated as a candidate cell and reselected as the next serving cell because H_{criteria}(=Qₘₑₐₛ−Q_{hcs}=10−0=10) of the cell “B” is greater than “0”. Then, the cell “A” is reselected as the serving cell because the RSCP of the cell “A” is greater than that of the cell “B” in the cell reselection.

When such ping pong phenomenon, as above described, occurs (S403), the mobile handset checks if the RSCP and E_{c}/N₀ of the cell “A” are greater than Q_{rxlevMin} and Q_{qualMin}, respectively (S404). In this example, the mobile handset discontinues the cell reselection because the RSCP (=30) of the cell “A” is greater than Q_{rxlevMin}(=25) and E_{c}/N₀(=20) of the cell “A” is greater than Q_{qualMin}(=15) (S405). Accordingly, the cell “A” is finally selected as the next serving cell.

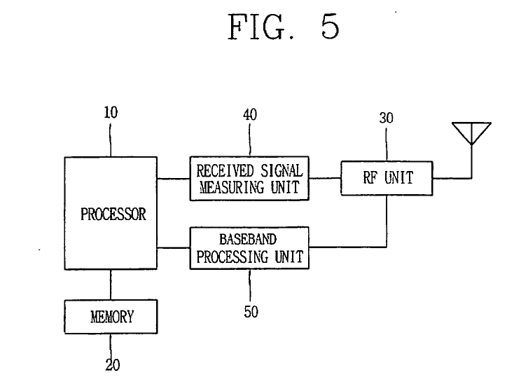

FIG. 5 shows a view of a configuration of the mobile handset to select and reselect a cell according to the present invention. The operations of FIGS. 3-4 are performed by the mobile handset of FIG. 5 or by other suitable device.

As shown in FIG. 5, the mobile handset according to the present invention includes a processor 10 controlling the operations of the mobile handset, a memory 20 storing information to be processed by the processor 10, an RF unit 30 receiving an RF signal and converting the RF signal to an IF signal, a received signal measuring unit 40 measuring a received signal code power (RSCP) and an Energy per Chip to Noise Ratio (Qₘₑₐₛ) of a signal received from the RF unit 30, and a baseband processing unit 50 converting the IF signal to a baseband signal. All components of the mobile handset are operatively coupled and configured.

The memory 20 includes a ROM storing an operation program, a RAM temporarily storing data generated during the running of the operation program, and an EEPROM to be programmed and reprogrammed. The minimum receive level Q_{rxlevMin} (dBm) in a cell and the minimum quality level Q_{qualMin} (dB) in a cell are stored in the EEPROM or in other suitable storage.

The RF unit 30 transmits and receives the RF signal to and from the base station through an antenna. The RF unit 30 converts the received RF signal to the IF signal and outputs the IF signal to the baseband processing unit 50. The RF unit 30 converts the IF signal input from the baseband processing unit 50 to the RF signal and transmits the RF signal.

The baseband processing unit 50 is a baseband analog ASIC (BAA) providing an interface between the processor 10 and the RF unit 30. The baseband processing unit 50 converts the baseband digital signal applied from the processor 10 to the analog IF signal and applies the analog IF signal to the RF unit 30. The baseband processing unit 50 converts the analog signal applied from the RF unit 30 to the baseband digital signal and applies the baseband digital signal to the processor 10.

The received signal measuring unit 40 measures the RSCP and the Energy per Chip to Noise Ratio (E_{c}/N₀) and applies the measured RSCP and the Energy per Chip to Noise Ratio (E_{c}/N₀) values to the processor 10.

The operation is now described which the mobile handset having the above configuration performs.

The RF unit 30, when the mobile handset initialized, receives signals from cells which are searched for through the antenna. The received signal measuring unit 40 measures the RSCP and the Energy per Chip to Noise Ratio (E_{c}/N₀) of each of signals received from the cells. Values measured by the received signal measuring unit 40 are sent to the processor 10. The processor 10 selects the cell of which the RSCP is the strongest of the cells which are searched after. The processor 10 retrieves threshold values Q_{rxlevMin} and Q_{qualMin} from the memory 20 and checks if the RSCP and the Energy per Chip to Noise Ratio (E_{c}/N₀) of each of the signals are greater than Q_{rxlevMin} and Q_{qualMin} respectively. The processor 10 designates as a serving cell the cell of which the RSCP and the Energy per Chip to Noise Ratio (E_{c}/N₀) are greater than Q_{rxlevMin} and Q_{qualMin} respectively.

Thereafter, one of the following two processes is performed by the mobile handset according to the cell selection and reselection process of the present invention.

The first process is as follows. The received signal measuring unit 40 measures the RSCP and E_{c}/N₀ of each of the current serving cell and the adjacent cells, and sends the measured RSCP and E_{c}/N₀ values to the processor 10. The processor 10 designates the current serving cell as a candidate cell for a next serving cell in the cell reselection, when the RSCP of the current serving cell is the strongest of all cells (e.g., step S308).

The processor 10 calculates H_{criteria} of each of the adjacent cells which are searched for. H_{criteria} of each of the adjacent cells is given by the following formula,
H_{criteria}=Qₘₑₐₛ−Q_{hcs}
wherein Qₘₑₐₛ is an Energy per Chip to Noise Ratio value measured by and provided from the received signal measuring unit 40, and Q_{hcs} is a reference value for an Energy per Chip to Noise Ratio value, which is provided from the network and stored in the memory 20. The processor 10 designates as a candidate cell for the next serving cell in the cell reselection each cell whose H_{criteria} is greater than “0” (e.g., S310). The processor then reselects the next serving cell from all the candidate cells (e.g., S311).

The second process is as follows. The received signal measuring unit 40 measures the RSCP and E_{c}/N₀ of each of the current serving cell and the adjacent cells, and sends the measured the RSCP and E_{c}/N₀ values to the processor 10. The processor 10 calculates H_{criteria} of each of the current serving cell and the adjacent cells. H_{criteria} of each of the adjacent cells is given by the following formula,
H_{criteria}=Qₘₑₐₛ−Q_{hcs}
wherein Qₘₑₐₛ is an Energy per Chip to Noise Ratio value measured by and provided from the received signal measuring unit 40, and Q_{hcs} is a reference value for an Energy per Chip to Noise Ratio value, which is provided from the network and stored in the memory 20. The processor 10 designates as a candidate cell for the next serving cell in the cell reselection any cell whose H_{criteria} is greater than “0”, regardless whether the cell is the current serving cell or an adjacent cell (e.g., S402).

At this point, the processor 10 checks if the selection and reselection process is repeated between the current serving cell and other cells (e.g., S403). When a number of occurrences of the ping pong phenomenon exceeds a predetermined number, the processor 10 receives the measured RSCP and E_{c}/N₀ values of the current serving cell from the received signal measuring unit 40, and checks if the measured RSCP and E_{c}/N₀ values of the current serving cell are greater than Q_{rxlevMin} and Q_{qualMin}, respectively (e.g., S404). The processor 10 discontinues the cell reselection process when the measured RSCP and E_{c}/N₀ values of the current serving cell are greater than Q_{rxlevMin} and Q_{qualMin}, respectively (e.g., S405).

Accordingly, the present invention prevents the cell reselection from occurring when the signal reception sensitivity and channel quality of the current serving cell does not satisfy specified requirements of the network, but turns out to be good enough to satisfy specified requirements stored in the mobile handset. In that case, the current serving cell is maintained as the serving cell. Thus, it is possible to prevent the ping pong phenomenon from causing a decrease in the system performance.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for selecting and reselecting a cell in a mobile handset, comprising:
measuring a received signal code power of each of a current serving cell and adjacent cells; and
designating the current serving cell as a candidate cell for a next serving cell in a cell reselection process, if the received signal code power of the current serving cell is the strongest of all the cells.

2. The method for selecting and reselecting a cell in a mobile handset according to claim 1, further comprising:
designating as a candidate cell for the next serving cell in the cell reselection process, any of the adjacent cell of which a measured signal quality satisfies a reference value (Q_{hcs}) which a network requires of the adjacent cell.

3. The method for selecting and reselecting a cell in a mobile handset according to claim 1, wherein if the received signal code power of the current serving cell is not the strongest of all the cells, the method further comprises:
measuring a signal quality of the current serving cell and the adjacent cells; and
designating any of the current serving cell and the adjacent cells that has the measured signal quality satisfying a reference value (Q_{hcs}), as a candidate cell for the next serving cell in the cell reselection process.

4. The method for selecting and reselecting a cell in a mobile handset according to claim 3, wherein in the measuring step, the signal quality indicates an Energy per Chip to Noise Ratio calculated based on a received signal.

5. The method for selecting and reselecting a cell in a mobile handset according to claim 3, wherein in the designating step, the measured signal quality of each of the current serving cell and the adjacent cells is determined as satisfying the reference value (Q_{hcs}) if an Energy per Chip to Noise Ratio of that cell is greater than the reference value (Q_{hcs}).

6. The method for selecting and reselecting a cell in a mobile handset according to claim 3, wherein in the designating step, the reference value (Q_{hcs}) is a minimum signal quality value which a network requires of the current serving cell.

7. A method for selecting and reselecting a cell in a mobile handset, comprising:
measuring a received signal code power and an Energy per Chip to Noise Ratio of each of a current serving cell of the mobile handset and adjacent cells searched by the mobile handset;
designating the current serving cell as a candidate cell for a next serving cell in a cell reselection when the received signal code power of the current serving cell is the strongest of all the cells;
designating, as a candidate cell for the next serving cell in a cell reselection, any of the adjacent cell of which the measured Energy per Chip to Noise Ratio value satisfies a reference value (Q_{hcs}); and
selecting a serving cell from the candidate cells.

8. The method for selecting and reselecting a cell in a mobile handset according to claim 7, wherein if the received signal code power of the current serving cell is not the strongest of all the cells, the method further comprises
designating, as a candidate cell for the next serving cell in a cell reselection, any of the cells of which the measured Energy per Chip to Noise Ratio value satisfies the reference value(Q_{hcs}), regardless of whether that cell is the current serving cell or one of the adjacent cells.

9. The method for selecting and reselecting a cell in a mobile handset according to claim 7, wherein in the designating step for the adjacent cells, the measured Energy per Chip to Noise Ratio value satisfies the reference value (Q_{hcs}) if the Energy per Chip to Noise Ratio is greater than the reference value (Q_{hcs}).

10. The method for selecting and reselecting a cell in a mobile handset according to claim 7, wherein the reference value (Q_{hcs}) is a minimum signal quality value which a network requires of the current serving cell.

11. A method for selecting and reselecting a cell in a mobile handset, comprising:
checking if a ping pong phenomenon occurs;
measuring a received signal code power and a signal quality of a current serving cell when a number of occurrences of the ping pong phenomenon exceeds a predetermined number; and
discontinuing a cell reselection when the received signal code power and the signal quality of the current serving cell satisfy threshold values Q_{rxlevMin} and Q_{qualMin}, respectively.

12. The method for selecting and reselecting a cell in a mobile handset according to claim 11, wherein in the checking step, when an adjacent cell is reselected instead of the current serving cell and the current serving cell is again reselected instead of the adjacent cell, the checking step determines that the ping pong phenomenon has occurred one time.

13. The method for selecting and reselecting a cell in a mobile handset according to claim 11, wherein the signal quality indicates an Energy per Chip to Noise Ratio calculated based on a received signal.

14. The method for selecting and reselecting a cell in a mobile handset according to claim 11, wherein the threshold values, Q_{rxlevMin} and Q_{qualMin} are minimum values for the received signal code power and the signal quality, which are preset in the mobile handset.

15. A mobile handset comprising:
a signal receiving unit receiving a signal from each of a current serving cell and adjacent cells;
a received signal measuring unit measuring a received signal code power and an Energy per Chip to Noise Ratio of the signal received from each of the current serving cell and the adjacent cells;
a memory storing values measured by the received signal measuring unit and reference values (Q_{hcs}) for cell reselection; and
a processor performing a process-of automatically designating the current serving cell as a candidate cell for a next serving cell in a cell reselection if the current serving cell has the strongest received signal code power among all the cells.

16. The mobile handset according to claim 15, wherein the processor designates each of the current serving cell and the adjacent cells that has the measured Energy per Chip to Noise Ratio value satisfying the respective reference value (Q_{hcs}), as a candidate cell for the next serving cell in a cell reselection, if the current serving cell does not have the strongest received signal code power among all the cells.

17. The mobile handset according to claim 16, wherein the reference value (Q_{hcs}) is a minimum signal quality value which a network requires of the current serving cell.

18. A mobile handset comprising:
a signal receiving unit receiving a signal from each of a current serving cell and adjacent cells;
a received signal measuring unit measuring a received signal code power and an Energy per Chip to Noise Ratio of the signal received from each of the current serving cell and the adjacent cells;
a memory storing values measured by the received signal measuring unit and threshold values Q_{rxlevMin} and Q_{qualMin} for cell reselection; and
a processor discontinuing a cell reselection when the received signal code power and the Energy per Chip to Noise Ratio respectively satisfy the threshold values Q_{rxlevMin} and Q_{qualMin} stored in the memory.

19. The mobile handset according to claim 18, wherein the threshold values Q_{rxlevMin} and Q_{qualMin} are minimum values for the received signal code power and the Energy per Chip to Noise Ratio, respectively, which are preset and stored in the memory.

20. The mobile handset according to claim 18, wherein the processor discontinues the cell reselection only when a number of occurrences of a ping pong phenomenon exceeds a predetermined number.
